(19) United States
(12) Patent Application Publication
(10) Pub. No.: US 2025/0337191 A1
(43) Pub. Date: Oct. 30, 2025

(54) ELECTRICAL CONNECTOR ASSEMBLY FOR A DOMESTIC APPLIANCE

(71) Applicant: Haier US Appliance Solutions, Inc., Wilmington, DE (US)

(72) Inventors: Eric Gregory Tauzer, Louisville, KY (US); Edward Philip Strauss, Louisville, KY (US); Steve Bernard Froelicher, Shepherdsville, KY (US)

(21) Appl. No.: 18/647,669

(22) Filed: Apr. 26, 2024

(51) Int. Cl. H01R 13/62; F25D 23/02; H01R 13/24; H01R 24/66; H01R 24/76; H01R 101/00

(52) U.S. Cl. CPC H01R 13/6205; F25D 23/028; H01R 13/2421; H01R 13/2471; H01R 24/66; H01R 24/76; F25D 2400/40; H01R 2101/00

(57) ABSTRACT

A domestic appliance may include a frame including a front face and a rear face. The domestic appliance may include a door that may include a pin housing that may include a channel that may define an aperture therethrough. The domestic appliance may further include an electrical connector assembly. The electrical connector assembly may include a first electrical connector disposed at the frame and may include a contact pad and a first magnetic element. The first magnetic element may be coupled to the contact pad. The first magnetic element may be disposed at the rear face. The first magnetic element may define a magnetic field and may include a second electrical connector disposed at the pin housing. The second electrical connector may include a second magnetic element floating within the aperture. The second magnetic element may be in selective engagement with the contact pad.

### FIELD OF THE DISCLOSURE

The present subject matter relates generally to a domestic appliance and more particularly to an electrical connector assembly for a domestic appliance.

### BACKGROUND OF THE DISCLOSURE

Domestic appliances, such as refrigerator appliances, often include a cabinet that defines one or more chilled chambers for receipt of food articles for storage. Typically, one or more doors are rotatably hinged to the cabinet to permit selective access to food items stored in the chilled chamber. The domestic appliance can include one or more power consuming elements positioned at, or within, the doors The one or more power consuming elements can include a control panel, an ice or water dispenser, a user interface display, or any component positioned within the door that requires an electrical load for operation.

The power consuming elements can be hardwired (e.g., permanently connected) or selectively wired (e.g., connected when the door is in a closed position) to a power supply positioned within the cabinet. However, drawbacks exist with both hardwiring and selective wiring of the power consuming elements to the power supply. For example, hardwiring of the power consuming elements to the power supply requires wires to be routed through hinges that connect the door to the cabinet. These wires can be susceptible to damage caused by repeated bending of the hinge and therefore the wires within the hinge. As another example, selective wiring of the power consuming elements to the power supply can require robust and precise electrical connection points to be made between the door and the cabinet. These electrical connection points are susceptible to a high-resistance connection which can lead to a decrease in the efficiency and reliability of the electrical connection.

Accordingly, a refrigerator appliance that obviates one or more of the above-mentioned drawbacks would be beneficial.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a domestic appliance is provided. The domestic appliance may include a frame. The frame may include a front face and a rear face. The domestic appliance may include a door moveably attached to the frame between an open position and a closed position. The door may include a pin housing. The pin housing may include a channel that may define an aperture therethrough. The domestic appliance may include an electrical connector assembly for supplying an electrical load. The electrical connector assembly may be transitionable between an engaged position and a disengaged position, The electrical connector assembly may include a first electrical connector disposed at the frame. The first electrical connector may include a contact pad and a first magnetic element. The contact pad may be disposed at the front face apart from the door. The first magnetic element may be coupled to the contact pad. The first magnetic element may be disposed at the rear face. The first magnetic element may define a magnetic field. The electrical connector assembly may include a second electrical connector disposed at the pin housing. The second electrical connector may include a second magnetic element floating within the aperture. The second magnetic element may be in selective engagement with the contact pad. The first magnetic element may apply a pull force to the second magnetic element to maintain engagement between the second magnetic element and the contact pad in the engaged position.

In another exemplary aspect of the present disclosure, a refrigerator appliance is provided. The refrigerator appliance may include a cabinet that may include a front frame. The refrigerator appliance may include a door moveably attached to the cabinet between an open position and a closed position. The door may include a pin housing. The pin housing may include a channel that may define an aperture therethrough. The refrigerator appliance may include an electrical connector assembly for supplying an electrical load. The electrical connector assembly may include a first electrical connector disposed at the front frame. The first electrical connector may include a contact pad and a first magnetic element. The contact pad may be attached to a front face of the front frame apart from the door. The first magnetic element may be attached to the contact pad. The first magnetic element may be positioned at a rear face of the front frame. The first magnetic element may define a magnetic field. The electrical connector assembly may include a second electrical connector disposed at the pin housing. The second electrical connector may include a second magnetic element extended through the aperture. The second magnetic element may be in selective operative engagement with the first magnetic element to motivate the second magnetic element between an engaged position and a disengaged position with the contact pad.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to one or more exemplary embodiments of the present subject matter.

FIG. 2 provides a perspective view of the exemplary refrigerator appliance of FIG. 1, with the doors of the fresh food chamber and freezer chamber shown in an open position.

FIG. 3 provides a plan view of an electrical connector assembly of the exemplary refrigerator appliance of FIG. 1.

FIG. 4 provides a perspective view of a magnetic element of the electrical connector assembly of FIG. 3, wherein the magnetic element is in a compressed position.

FIG. 5 provides a perspective view of a magnetic element of the electrical connector assembly of FIG. 3, wherein the magnetic element is in a natural position.

FIG. 6 provides an exploded view of a magnetic element of the electrical connector assembly of FIG. 3.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

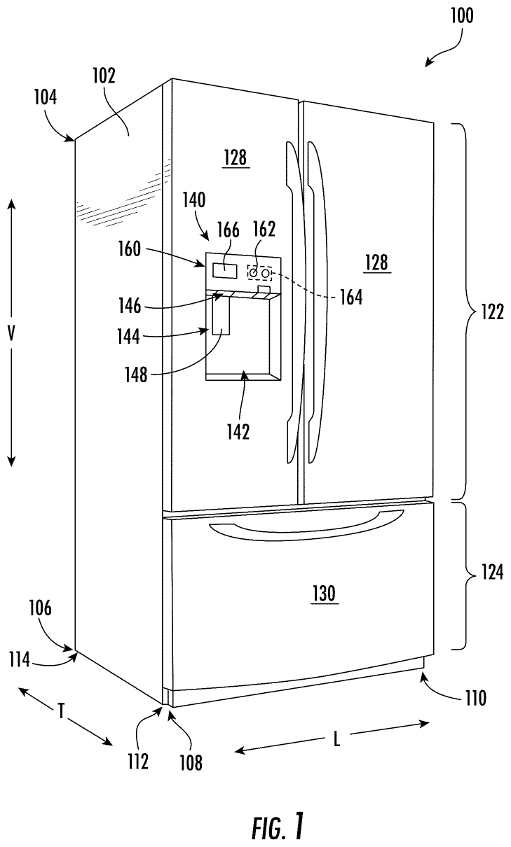

Turning now to the figures, FIG. 1 provides a perspective view of a refrigerator appliance 100 according to an exemplary embodiment of the present disclosure. Refrigerator appliance 100 includes a cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another.

Cabinet 102 defines chilled chambers for receipt of food items for storage. In particular, cabinet 102 defines fresh food chamber 122 positioned at or adjacent top 104 of cabinet 102 and a freezer chamber 124 arranged at or adjacent bottom 106 of cabinet 102. As such, refrigerator appliance 100 is generally referred to as a bottom mount refrigerator. It is recognized, however, that the benefits of the present disclosure apply to other types and styles of refrigerator appliance 100s such as, e.g., a top mount refrigerator appliance 100, a side-by-side style refrigerator appliance 100, or a single door 128 refrigerator appliance 100. Consequently, the description set forth herein is for illustrative purposes only and is not intended to be limiting in any aspect to any particular refrigerator chamber configuration.

Refrigerator doors 128 are rotatably hinged to an edge of cabinet 102 for selectively accessing fresh food chamber 122. In addition, a freezer door 128 130 is arranged below refrigerator doors 128 for selectively accessing freezer chamber 124. Freezer door 128 130 is coupled to a freezer drawer (not shown) slidably mounted within freezer chamber 124. Refrigerator doors 128 and freezer door 128 130 are shown in the closed configuration in FIG. 1. One skilled in the art will appreciate that other chamber and door 128 configurations are possible and within the scope of the present invention.

Referring now generally to FIG. 1, a dispensing assembly 140 will be described according to exemplary embodiments of the present disclosure. Dispensing assembly 140 is generally configured for dispensing liquid water or ice. Although an exemplary dispensing assembly 140 is illustrated and described herein, it should be appreciated that variations and modifications may be made to dispensing assembly 140 while remaining within the present disclosure.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a contact paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the contact paddle. Discharging outlet 146 and actuating mechanism 148 are an external part of ice dispenser 144 and are mounted in dispenser recess 142.

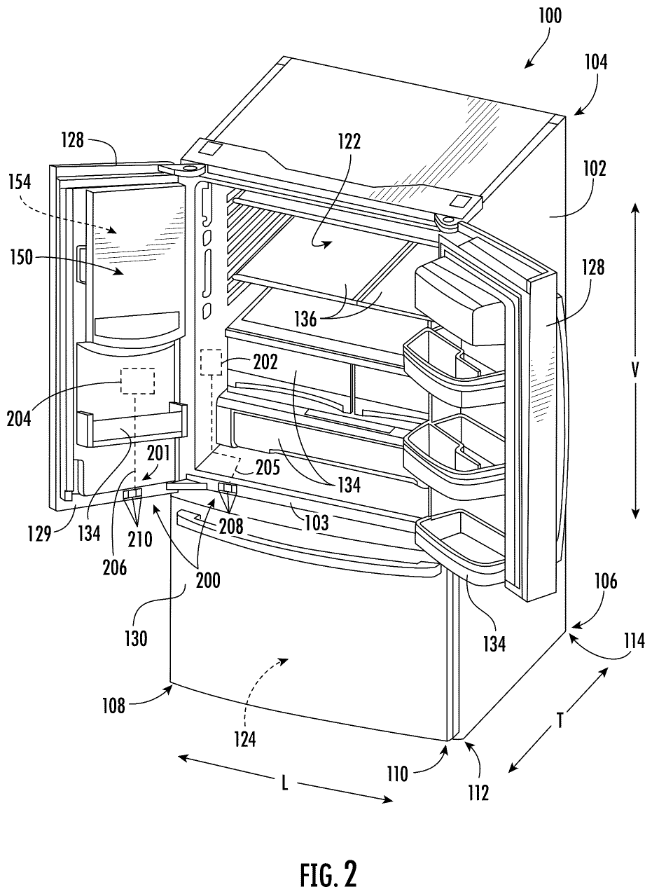

By contrast, inside refrigerator appliance 100, refrigerator door 128 may define an icebox 150 (e.g., FIG. 2) housing an icemaker and an ice storage bin 152 that are configured to supply ice to dispenser recess 142. In this regard, for example, icebox 150 may define an ice making chamber 154 for housing an ice making assembly, a storage mechanism, and a dispensing mechanism.

A control panel 160 is provided for controlling the mode of operation. For example, control panel 160 includes one or more selector inputs 162, such as knobs, buttons, touchscreen interfaces, etc., such as a water dispensing button and an ice-dispensing button, for selecting a desired mode of operation such as crushed or non-crushed ice. In addition, inputs 162 may be used to specify a fill volume or method of operating dispensing assembly 140. In this regard, inputs 162 may be in communication with a processing device or controller 164. Signals generated in controller 164 operate refrigerator appliance 100 and dispensing assembly 140 in response to selector inputs 162. Additionally, a display 166, such as an indicator light or a screen, may be provided on control panel 160. Display 166 may be in communication with controller 164 and may display information in response to signals from controller 164.

As used herein, “processing device” or “controller” may refer to one or more microprocessors or semiconductor devices and is not restricted necessarily to a single element. The processing device can be programmed to operate refrigerator appliance 100 and dispensing assembly 140. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions or data that when executed by the processing device, cause the processing device to perform operations.

Referring now to FIG. 2, a perspective view of refrigerator appliance 100 shown with refrigerator doors 128 in the open position is provided. The refrigerator appliance 100 may include various storage components mounted within fresh food chamber 122 to facilitate storage of food items therein as will be understood by those skilled in the art. In particular, the storage components may include bins 134 and shelves 136. Each of these storage components are configured for receipt of food items (e.g., beverages or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

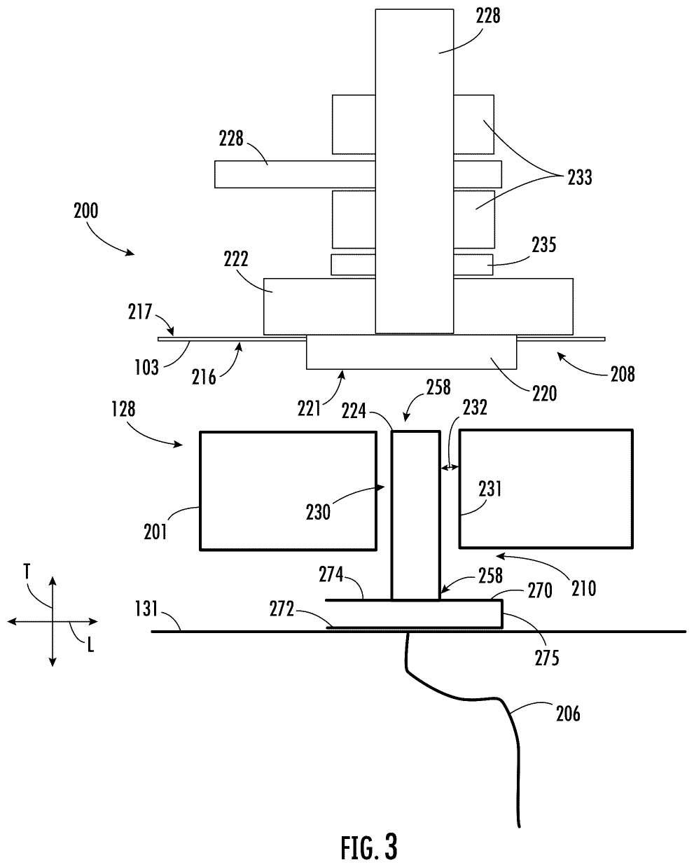

In some embodiments, one or more power consuming elements 204 are disposed at the doors 128 of the refrigerator appliance 100. Specifically, the one or more power consuming elements 204 may be attached to, positioned within, or otherwise apart of the doors 128. For example, the one or more power consuming elements may include components of the dispensing assembly 140 such as a sensor of the dispensing assembly 140, display 166, controller 164, or any other suitable element disposed at the doors 128 that may consume electrical power for operation. As the available space within the interior of the doors 128 may be limited, the power supply for these power consuming elements 204 may be positioned within the cabinet 102. Though shown schematically in FIG. 3, it should be appreciated that the power supply 202 may be positioned at any suitable location within the cabinet 102. For example, the power supply 202 may be positioned within the walls of the cabinet 102 such as at the rear side 114 of the cabinet 102.

In some embodiments, the refrigerator appliance 100 includes an electrical connector assembly 200 that is capable of selectively delivering an electrical load (e.g., power) to the one or more power consuming elements 204 disposed at the doors 128 of the refrigerator appliance 100. Specifically, the electrical connector assembly 200 may selectively transition between an engaged position and a disengaged position to selectively form an electrical pathway between a power supply 202 disposed at the cabinet 102 and the one or more power consuming elements 204. The electrical connector assembly 200 may be in the engaged position when (e.g., in response to) the door 128 is in the closed position. In the engaged position, the electrical connector assembly 200 may form the electrical pathway to deliver an electrical load from the power supply 202 to the one or more power consuming elements 204. The electrical connector assembly 200 may be in the disengaged position when the door 128 is in the open position. In the disengaged position, the electrical pathway formed by the electrical connector assembly 200 may be broken. Thus, in the disengaged position, an electrical load may not be delivered from the power supply 202 to the one or more power consuming elements 204.

The electrical connector assembly 200 may generally include a plurality of first electrical connectors 208 and a plurality of second electrical connectors 210. The plurality of first electrical connectors 208 may be disposed at a front frame 103 of the cabinet 102. The front frame 103 may define an opening of the fresh food chamber 122. For instance, the front frame 103 of the cabinet 102 may be positioned at the front side 112 of the cabinet 102 and may define a front outer edge or surface of the cabinet 102. The plurality of second electrical connectors 210 may be disposed at a complementary location (e.g., a location complementary to the location of the first electrical connector 208) on an outer trim piece 129 of the doors 128. For instance, the plurality of second electrical connectors 210 may be positioned on the outer trim piece 129 such that when the door 128 is in the closed position the plurality of first electrical connectors 208. Moreover, in the closed position, the plurality of second electrical connectors 210 may come into intimate contact with one another to form an electrical pathway.

As will be appreciated in more detail below, the exemplary electrical connector assembly 200 may advantageously include one or more magnets or ferromagnetic materials that are disposed at the plurality of first electrical connectors 208 or the plurality of second electrical connectors 210. The one or more magnets or ferromagnetic materials may advantageously ensure adequate contact forces are maintained between the plurality of first electrical connectors 208 and the plurality of second electrical connectors 210 in the engaged position. In this regard, high resistance connections (e.g., a loose or poor connection between the first electrical connector 208 and the second electrical connector 210) can be prevented or avoided.

Referring now to FIG. 3, a plan view of a discrete first electrical connector 208 and a corresponding discrete second electrical connector 210 of the electrical connector assembly 200 are provided. The first electrical connector 208 may be disposed at the front frame 103, and more particularly, at a front face 216 of the front frame 103. The first electrical connector 208 may extend through the front face 216 of the front frame 103, such that at least a portion of the first electrical connector 208 is disposed at, or in front of, the front face 216 of the front frame 103.

In some embodiments, the first electrical connector 208 generally includes a contact pad 220 and a first magnetic element 222. The contact pad 220 may be disposed at, or in front of, the front face 216 of the front frame 103. For example, the contact pad 220 may be positioned at the front face 216 such that an engagement surface 221 of the contact pad 220 sits flush with the front frame 103. As another example, the contact pad 220 may be extended outward (e.g., along the transverse direction T) from the front face 216 such that the engagement surface 221 is protruded from the front frame 103. The engagement surface 221 may be a flat or concave surface that a second magnetic element 224 (e.g., described in more detail below) of the second electrical connector 210 may selectively engage with. When engaged, the second magnetic element 224 may be in intimate contact with the engagement surface 221 of the contact pad 220 and an electrical pathway may be formed between the power supply 202 positioned within the cabinet 102 and the power consuming element 204 positioned within the door 128.

The first magnetic element 222 may be positioned at, or proximate to, a rear face 217 of the front frame 103. In some embodiments, the first magnetic element 222 may be coupled around a stem 226 of the first electrical connector 208. The stem 226 may extend into the front frame 103 from the contact pad 220. For instance, the stem 226 may be attached to or coupled to the contact pad 220 such that the stem 226 and the contact pad 220 are in electrical communication. A first electrical supply line 205 positioned within the cabinet 102 may be connected to the stem 226. In some embodiments, the first electrical supply line 205 includes a ring terminal that is coupled to the stem 226. For example, the ring terminal of the first electrical supply line 205 may be fit over the stem 226 and coupled to the stem 226 via one or more locking elements described in more detail below. In this regard, the stem 226 and the first electrical supply line 205 are in electrical communication. The first electrical supply line 205 may be capable of providing an electrical load from the power supply 202 to the first electrical connector 208 via the stem 226 and the contact pad 220.

It is understood that the first magnetic element 222 or the second magnetic element 224 may be formed from any material that is suitably responsive to a magnetic field or capable of generating a magnetic field. In other words, the first magnetic element 222 or the second magnetic element 224 are not formed from a purely diamagnetic material. The first magnetic element 222 or the second magnetic element 224 may be formed from the same material or unique materials. As an example, the first magnetic element 222 may be one of a permanent magnet, ferromagnetic element, or an electromagnetic element while the second magnetic element 224 is another of a permanent magnet, ferromagnetic element, or an electromagnetic element. As another example, the first magnetic element 222 may be one of a permanent magnet, ferromagnetic element, or electromagnetic element while the second magnetic element 224 is the same of a permanent magnet, ferromagnetic element, or electromagnetic element.

Additionally or alternatively, the first electrical connector 208 may include one or more locking elements for securing or locking the contact pad 220 and the first magnetic element 222 in place relative to the cabinet 102, and more particularly, to the front frame 103 of the cabinet 102. In some embodiments, the one or more locking elements include one or more locking nuts 233 and a locking washer 235 coupled around the stem 226. For instance, the one or more locking nuts 233 may be coupled to the stem 226 above and below the first electrical supply line 205. However, in additional or alternative exemplary embodiments, any suitable locking elements that are capable of securing the contact pad 220 and the first magnetic element 222 in place may be incorporated into the first electrical connector 208. For example, in alternative embodiments, the one or more locking elements may include snap fit features, mounting plates, screws, etc.

The second electrical connector 210 may be disposed at a pin housing 201 of the door 128. The pin housing 201 may include a channel 231 that defines an aperture 230 for housing the second magnetic element 224 of the second electrical connector 210. In some embodiments, the second magnetic element 224 may “float” within the aperture 230. Specifically, the second magnetic element 224 may be extended through the aperture 230 such that a radial gap 232 is defined between the second magnetic element 224 and the channel 231. The radial gap 232 between the second magnetic element 224 and the channel 231 may provide a clearance for the second magnetic element 224 to move (e.g., along the transverse direction T) within the aperture 230. For instance, the radial gap 232 between the second magnetic element 224 and the channel 231 may notably mitigate unnecessary contact between the second magnetic element 224 and the channel 231 that may otherwise lead to sparking or carbon build up.

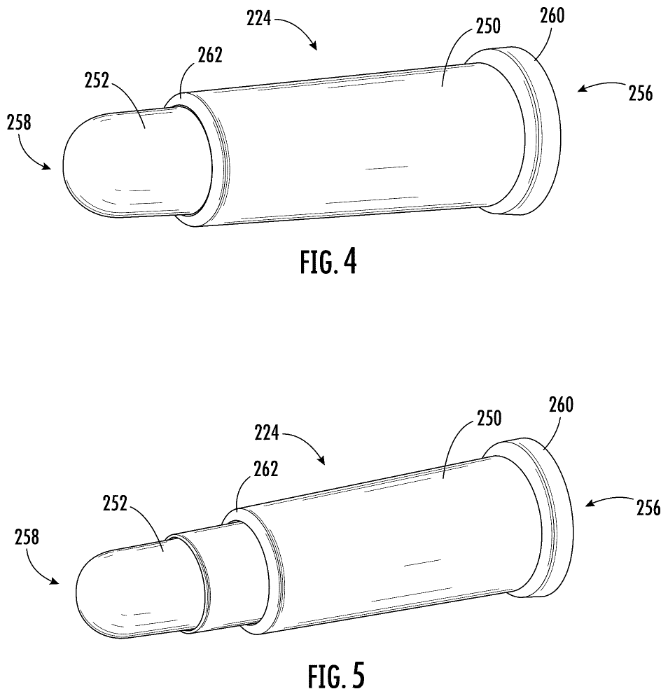

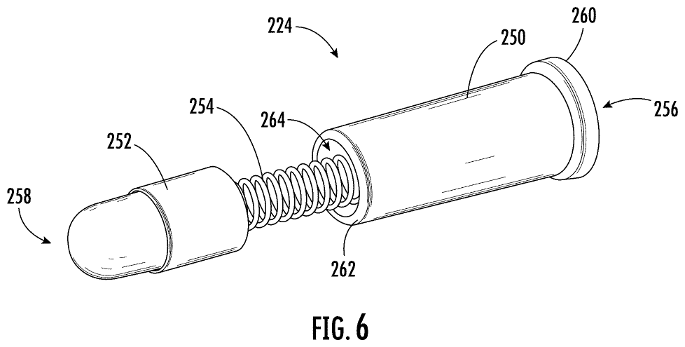

Referring now to FIGS. 4 through 6, the second magnetic element 224 may include a barrel 250, a plunger 252, and a spring 254. The second magnetic element 224 may generally extend between a proximal end 256 and a distal end 258 (e.g., along the transverse direction T). The barrel 250 may include a first end 260 and a second end 262. The first end 260 may be disposed at the proximal end 256 of the second magnetic element 224. The second end 262 may be positioned between the proximal end 256 and the distal end 258 of the second magnetic element 224. The barrel 250 may also define an opening 264 (e.g., FIG. 6) at the second end 262 thereof.

The plunger 252 may be positioned within the opening 264 of the barrel 250. Particularly, the spring 254 may be coupled to the plunger 252 and positioned within the opening 264 of the barrel 250. A first side of the spring 254 may engage with the first end 260 of the barrel 250 (e.g., within the opening of the barrel 250). A second side of the spring 254 may be coupled to the plunger 252. The spring 254 may selectively transition the plunger 252 between a compressed position (e.g., FIG. 4) and a natural (e.g., FIG. 5). For example, when the electrical connector assembly 200 is in the engaged position, the plunger 252 may be transitioned to the compressed position. In the compressed position, the spring 254 may apply a spring force (e.g., a force directed toward the contact pad 220) to the plunger 252 and ultimately to the contact pad 220 that the plunger 252 may be in intimate contact with.

Referring back to FIG. 3, in additional or alternative exemplary embodiments, the second electrical connector 210 includes an actuation element 270 attached to the proximal end 256 of the second magnetic element 224. The actuation element 270 may be disposed within the door 128. The actuation element 270 may be any suitable element that is capable of actuating the second magnetic element 224. For example, the actuation element 270 may be a spring, such as a leaf spring. In some embodiments, the actuation element 270 may be a leaf spring that includes a first member or plate 272 and a second member or plate 274. The first member 272 may be fixed to a predetermined surface 131 of the door 128 (e.g., wherein the predetermined surface 131 is positioned within an interior cavity of the door 128 such as within the outer trim piece 129). For example, the first member 272 may be fastened (e.g., mechanically fastened) to the predetermined surface 131 such that the first member 272 is stationary relative to the door 128.

The second member 274 may be extended from the first member 272 and may be attached to the proximal end 256 of the second magnetic element 224. The second member may be a resilient member of the actuation element 270 that is capable of moving (e.g., approximately along the transverse direction T) between a natural position (e.g., FIG. 3) and one or more forced position wherein the second member 274 is expanded away from the first member 272 or compressed toward the first member 272. For instance, in some embodiments, the second member 274 includes a hinge 275 that connects the first member 272 to the second member 274. The hinge 275 may be the resilient portion of the actuation element 270 that is capable of moving the second member 274. The second member 274 may be biased toward the natural position.

According to one or more exemplary embodiments of the present disclosure, the electrical connector assembly 200 may be transitionable between an engaged position and a disengaged position. As an illustrative example, to transition the electrical connector assembly 200 from the disengaged position to the engaged position, the door 128 of the refrigerator appliance must be moved from the open position to the closed position. As the door 128 is moved from the open position to the closed position, the second magnetic element 224 of the second electrical connector 210 may enter the magnetic field formed by the first magnetic element 222. When in the magnetic field, the first magnetic element 222 may apply a pull force to the second magnetic element 224. The second member 274 of the actuation element 270 may allow the second magnetic element 224 to move toward the first magnetic element 222. Particularly, the actuation element 270 may be capable of expanding (e.g., along the transverse direction T) to accommodate the movement of the second magnetic element 224 when the second magnetic element 224 is in the magnetic field of the first magnetic element.

Furthermore, the pull force exerted onto the second magnetic element 224 may pull the distal end 258 of the second magnetic element 224 into intimate contact with the engagement surface 221 of the contact pad 220. The pull force may maintain intimate contact between the contact pad 220 and the second magnetic element 224 when in the electrical connector assembly 200 is engaged position. Additionally or alternatively, in the engaged position, the second magnetic element 224 may be in its compressed position (e.g., FIG. 4). In the compressed position, the spring 254 positioned within the second magnetic element 224 may apply a normal force to or toward the contact pad 220. This force may further assist in maintaining connection between the second magnetic element 224 and the contact pad 220 in the engaged position of the electrical connector assembly 200. When the second magnetic element 224 and the contact pad 220 are in intimate contact an electrical pathway may be formed. The electrical pathway may be utilized in delivering an electrical load from the power supply 202 to the one or more power consuming components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A domestic appliance comprising:
a frame comprising a front face and a rear face;
a door moveably attached to the frame between an open position and a closed position, the door comprising a pin housing, the pin housing comprising a channel defining an aperture therethrough; and
an electrical connector assembly for supplying an electrical load, the electrical connector assembly transitionable between an engaged position and a disengaged position, the electrical connector assembly comprising:
a first electrical connector disposed at the frame, the first electrical connector comprising a contact pad and a first magnetic element, the contact pad disposed at the front face apart from the door, the first magnetic element coupled to the contact pad, the first magnetic element disposed at the rear face, the first magnetic element defining a magnetic field; and
a second electrical connector disposed at the pin housing, the second electrical connector comprising a second magnetic element floating within the aperture, the second magnetic element in selective engagement with the contact pad,
wherein the first magnetic element applies a pull force to the second magnetic element to maintain engagement between the second magnetic element and the contact pad in the engaged position.

2. The domestic appliance of claim 1, wherein one of the first magnetic element and second magnetic element comprises a permanent magnet and the other of the first magnetic element and second magnetic element comprises a ferromagnetic material.

3. The domestic appliance of claim 1, wherein the second electrical connector further comprises an actuation element, wherein the actuation element comprises a first member and a second member, wherein the first member is fixed to a predetermined surface within the door at the pin housing, wherein the second member is resiliently extended from the first member, and wherein a proximal end of the second magnetic element is coupled to the first member.

4. The domestic appliance of claim 3, wherein the second magnetic element and the channel define a radial gap therebetween.

5. The domestic appliance of claim 1, wherein the second magnetic element comprises a barrel, plunger, and a spring, wherein the barrel extends from a top end to a bottom end, wherein an opening is defined at the top end, wherein the plunger is mounted within the opening, wherein the spring is positioned within the barrel and the plunger, and wherein the plunger is moveable between a compressed position and a free position via the spring.

6. The domestic appliance of claim 1, wherein the contact pad is a plurality of contact pads, wherein the first magnetic element is a first plurality of magnetic elements, wherein the plurality of contact pads are attached to the front face of the frame apart from the door, and wherein each first magnetic element of the first plurality of magnetic elements is positioned at the rear face of the frame.

7. The domestic appliance of claim 6, wherein the aperture defined through the channel is a plurality of apertures defined through the channel, wherein the second magnetic element is a second plurality of magnetic elements, wherein each second magnetic element of the second plurality of magnetic elements is extended through an aperture of the plurality of aperture, and wherein each second magnetic element of the second magnetic elements is in selective operative engagement with each first magnetic element of the first plurality of magnetic elements to motive each second magnetic element between an engaged position and the disengaged position.

8. The domestic appliance of claim 1, further comprising:
a power supply positioned within the frame, the power supply in electrical communication with the first electrical connector to provide electric power to the first electrical connector.

9. The domestic appliance of claim 8, further comprising:
a power consuming element in electrical communication with the second magnetic element, wherein in the engaged position the electrical connector assembly supplies an electrical load from the power supply to the power consuming element.

10. A refrigerator appliance comprising:
a cabinet comprising a front frame;
a door moveably attached to the cabinet between an open position and a closed position, the door comprising a pin housing, the pin housing comprising a channel defining an aperture therethrough; and
an electrical connector assembly for supplying an electrical load, the electrical connector assembly comprising:
a first electrical connector disposed at the front frame, the first electrical connector comprising a contact pad and a first magnetic element, the contact pad attached to a front face of the front frame apart from the door, the first magnetic element attached to the contact pad, the first magnetic element positioned at a rear face of the front frame, the first magnetic element defining a magnetic field; and
a second electrical connector disposed at the pin housing, the second electrical connector comprising a second magnetic element extended through the aperture, the second magnetic element in selective operative engagement with the first magnetic element to motivate the second magnetic element between an engaged position and a disengaged position with the contact pad.

11. The refrigerator appliance of claim 10, wherein one of the first magnetic element and second magnetic element comprises a permanent magnet and the other of the first magnetic element and second magnetic element comprises a ferromagnetic material.

12. The refrigerator appliance of claim 10, wherein the second electrical connector further comprises an actuation element, wherein the actuation element comprises a first member and a second member, wherein the first member is fixed to a predetermined surface within the door at the pin housing, wherein the second member is resiliently extended from the first member, and wherein a proximal end of the second magnetic element is coupled to the first member.

13. The refrigerator appliance of claim 12, wherein the second magnetic element and the channel define a radial gap therebetween.

14. The refrigerator appliance of claim 10, wherein the second magnetic element comprises a barrel, plunger, and a spring, wherein the barrel extends from a top end to a bottom end, wherein an opening is defined at the top end, wherein the plunger is mounted within the opening, wherein the spring is positioned within the barrel and the plunger, and wherein the plunger is moveable between a compressed position and a free position via the spring.

15. The refrigerator appliance of claim 10, wherein the contact pad is a plurality of contact pads, wherein the first magnetic element is a first plurality of magnetic elements, wherein the plurality of contact pads are attached to the front face of the front frame apart from the door, and wherein each first magnetic element of the first plurality of magnetic elements is positioned at the rear face of the front frame.

16. The refrigerator appliance of claim 15, wherein the aperture defined through the channel is a plurality of apertures defined through the channel, wherein the second magnetic element is a second plurality of magnetic elements, wherein each second magnetic element of the second plurality of magnetic elements is extended through an aperture of the plurality of aperture, and wherein each second magnetic element of the second magnetic elements is in selective operative engagement with each first magnetic element of the first plurality of magnetic elements to motive each second magnetic element between an engaged position and the disengaged position.

17. The refrigerator appliance of claim 10, further comprising:
a power supply positioned within the front frame, the power supply in electrical communication with the first electrical connector to provide electric power to the first electrical connector.

18. The refrigerator appliance of claim 17, further comprising:
a power consuming element in electrical communication with the second magnetic element, wherein in the engaged position the electrical connector assembly supplies an electrical load from the power supply to the power consuming element.
